(19) United States
(12) Patent Application Publication
(10) Pub. No.: US 2022/0076324 A1
(43) Pub. Date: Mar. 10, 2022

(54) TERMINAL RENTAL SYSTEM

(71) Applicant: CO-CONV, Corp., Kyoto (JP)

(72) Inventor: Shin Maruyama, Toyonaka-shi, Osaka (JP)

(73) Assignee: CO-CONV, Corp., Kyoto (JP)

(21) Appl. No.: 17/431,065

(22) PCT Filed: Nov. 20, 2019
(86) PCT No.: PCT/JP2019/045456

§ 371 Date: Aug. 13, 2021

(30) Foreign Application Priority Data
Feb. 14, 2019 (JP) 2019-024559

(51) Int. Cl. G06Q 30/06; G06Q 10/02; G06Q 50/06

(52) U.S. Cl. CPC G06Q 30/0645; G06Q 50/06; G06Q 10/02

(57) ABSTRACT

To provide a terminal rental system that can efficiently perform rental management and maintenance operations. A terminal rental system includes a reservation management server for managing stock of terminals or rental reservation information for the terminals, a terminal management server for distributing a disk image of an operating system or its update data to the terminal, and a power feed control server for managing a system state and a power feed state of the terminal on the basis of the rental reservation information, a charge state of the terminal, and information relating a distribution status of the disk image or its update data.

### BACKGROUND

### Technical Field

This invention relates to a terminal rental system that provides a system for enabling many users to rent terminals.

### Background Art

Various systems for managing many computers at once are known (Patent Documents 1, 2, etc.). All of these systems have been put to practical use as terminal management servers that can start each terminal from any configuration state while keeping the operating system and security software up to date.

The terminal management server is a device that was initially developed to efficiently manage many computers (client terminals) in schools and companies. However, if the computer to be managed is a “portable, battery-powered computer” such as a laptop or tablet (hereinafter referred to as “terminal”), it is possible to achieve a usage style in which the terminal is rent to many users for a certain period of time and returned after use.

### CITATION LIST

### Patent Literature

Patent Document 1: Japanese Patent No. 6072352

Patent Document 2: Japanese Patent No. 4808275

### DISCLOSURE OF INVENTION

### Technical Problem

It is an object of the present invention to provide a system including storage devices to store many terminals. The storage device is, for example, a terminal storage section that is delimited as storage space having a lock, such as a locker, and one terminal is stored per terminal storage section. While managing the rental status whether the terminal is being rented or returned, the system can automatically update the operating system or the like and charge the terminal before the terminal is rented next. The problems that can be assumed to use this system are as follows.

First, terminals that are being activated or charged generate heat. Accordingly, if many terminals are started up at once, the heat amount will naturally increase. For example, a recent typical notebook computer may reach a maximum power consumption of 100 W per unit in order to support quick charging. In this case, for example, to safely manage the terminals using 1500 W (100V, 15 A), which is for one commercial power line, the number of terminals that can be started up or charged at the same time must be limited to 15 or less. Keeping them particularly in enclosed spaces, such as a locker, also has a risk of fire. However, a large-scale cooling mechanism is also costly and impractical to be employed.

Furthermore, it is known that the repeated charging of rechargeable batteries deteriorates the performance and the lifespan (number of charge/discharge frequency) decreases, and thus, all the batteries (terminals) that are not fully charged do not always mean to need being charged.

In this way, the storage device necessarily requires to be configured:

to monitor the charge state of each terminal in a standby mode and safely stop power feeding after charging is completed; and

to set an upper limit on the number of terminals chargeable at once, charge only the upper limit number of the terminals if the number of terminals to be charged exceeds the upper limit, and put the other terminals into a standby state without energizing.

These are especially important requirements, when the power required to supply terminals exceeds the available commercial power supply, for example, when many storage devices are installed in a location where only one commercial power line is available.

Second, if the returned terminal is rented to the next user as is, there is a risk of information leakage and other problems, and thus the terminal needs to be restored to at least the state before being rented. In addition, there are cases where it is necessary to make changes to the storage state after the terminal is returned (e.g., update of the operating system or security software, or rollbacks (restoring to the previous state)). In this case, the necessary work also needs be sequentially proceeded.

However, unlike terminals normally connected to the network and installed in a fixed location, terminals that are shared for the rental operation are not easy to be updated. This is because de-energized terminals have to be started remotely and selectively. In the case of a wireless connection to the network interface, the network bandwidth tends to be insufficient, and the connection also tends to be unstable. In the case of a wired connection, the terminal needs to be securely connected to a LAN cable or the like.

For example, if the operating system needs to be simply updated, it is sufficient to energize the terminal, to boot the operating system, and to patch the program. However, if each terminal is individually and repeatedly patched, each terminal will have a different disk state after the update, and thus, it is not suitable for the purpose of stably managing many terminals. In other words, “system update” is a broad concept that includes not only “OS updates and configuration changes”, but also “OS installation” and “the process of unifying the states of many terminal disks by erasing the use history of previous users (restoring to the original state)”.

As a matter of practical operation, it is necessary to ensure that the necessary cables are properly and securely connected to the terminal when the terminal is returned. If the charging cable is not properly connected, the terminal cannot start charging, and if the communication cable is not properly connected, system updates or the like cannot be performed. Furthermore, if the charging cable and communication cable are separate, the user has to connect multiple cables to the terminal, leading to an excessive burden on the user. There is the risk that the user may inadvertently forget to connect the cables or fail to sufficiently insert the cable into the terminal. There is also another risk of damaging cables, connectors, and other parts during repeated connection. All of these problems can prevent long-term unmanned operation. On the other hands, a system must not be configured that all terminals connected to a charging cables are immediately shifted to a charging or energized state, considering the problems that may be caused by the power circuits and heat generation, as described above.

A system with high scalability allowing more terminals to be rented is preferred. The term “scalability” herein refers to the ability of the system that many terminals can be rented at a single location and that many such locations can be provided.

In view of the above problems, the present invention has an object to provide a terminal rental system that can efficiently perform rental management and maintenance operations, in particular, to solve at least one of the technical problems described above.

### Solution to Problem

According to one aspect of the present invention, a terminal rental system is characterized to include:

a reservation management server for managing rental reservation information for terminals;

a terminal management server for distributing a disk image of an operating system or its update data to the terminal; and

a power feed control server for managing a power feed state of a terminal storage section on the basis of the rental reservation information, a charge state of the terminal, and information relating a distribution status of a disk image or its update data.

With such a configuration, the power feed control server can limit the number of terminals that can be charged and started at one time, and thus, it has an advantage of limiting the total power consumption as the entire system, thereby suppressing the amount of heat generated by the terminals to a safe level. In the case of unmanned management, the system can provide a “terminal locker having terminal storage sections with locks for storing terminals,” and the power feed control server can manage the locking status of the terminal storage sections. The function of the locker is to physically store the terminal safely, i.e., to prevent the terminal from being taken out unintentionally. If a storage location for the terminals and the minimum human resources to manage the rental and return of the terminals can be secured, for example, if there are bookshelves and a librarian in a library, a physical storage facility such as a locker and a configuration of a “locker control server” for managing the locking status of the lockers are unnecessary.

### Advantageous Effect

According to the terminal rental system of the present invention, it is possible to provide a terminal rental system that can efficiently perform rental management and maintenance operations. The term “efficiently” means that the human burden on the system administrator, the owner, can be minimized.

### BRIEF DESCRIPTION OF DRAWINGS

FIG. 1 is an entire configuration diagram of a terminal rental system according to an embodiment of the present invention;

FIG. 1-2 is an exemplified configuration diagram of the present system with a plurality of terminal lockers 20 arranged side by side (first embodiment);

FIG. 2 is a schematic configuration diagram of the terminal locker 20;

FIG. 2-2 is a photo of a prototype of the terminal locker 20, taken from above the front;

FIG. 2-3 is a photo of the prototype of the terminal locker 20 with a top plate removed, taken from the top direction;

FIG. 3(A) is a perspective view of a terminal storage section 21 of the terminal locker 20 where a terminal C is stored, and FIG. 3(B) is a perspective view of the terminal storage section 21 where the terminal C is removed (i.e., being rented);

FIG. 3-2 (A) is a schematic configuration diagram of the terminal storage section (only) with improvements added, and FIG. 3-2 (B) is a view of the terminal storage section 21 with a terminal tray 21a pulled out;

FIG. 4 is a schematic diagram illustrating the configuration of a terminal locker controller 28;

FIG. 5 is a functional block diagram of a terminal management box 22;

FIG. 5-2 is an actual configuration example of the block diagram of FIG. 5;

FIG. 6 is a functional block diagram of a data signal system of the terminal locker controller 28;

FIG. 7 is a functional block diagram of a power supply system of the terminal locker controller 28;

FIG. 8 is a processing flowchart of the terminal management box;

FIG. 8-2 are photos illustrating a processing flow of a rental phase;

FIG. 9 is a processing flowchart of a return phase;

FIG. 9-2 are photos illustrating a processing flow of the return phase;

FIG. 10 is a processing flowchart of an examination phase;

FIG. 11 is a flowchart of a charge/management phase;

FIG. 12 is a flowchart of a rental processing;

FIG. 13(A) is a processing flowchart of a standby state for power feeding, and FIG. 13(B) is a processing flowchart of a release state for power feeding;

FIG. 14 is a processing flowchart of a rental standby phase; and

FIG. 15 is a view of another embodiment (second embodiment) of the terminal rental system 10 according to the first embodiment of the present invention.

### EMBODIMENT

### First Aspect

### Entire Configuration

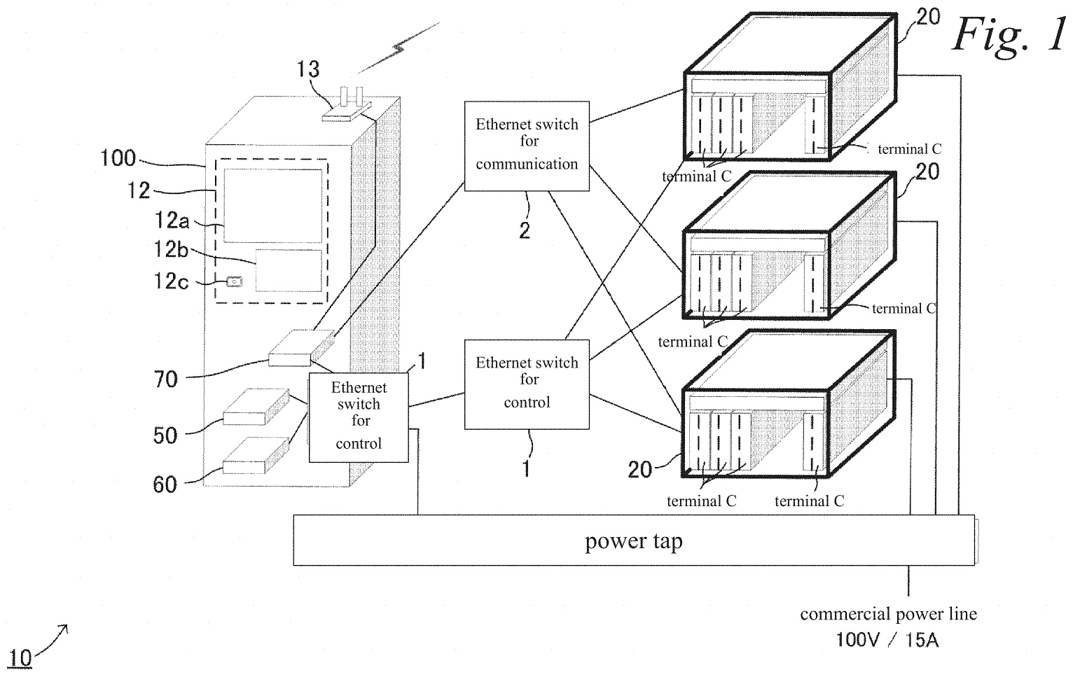

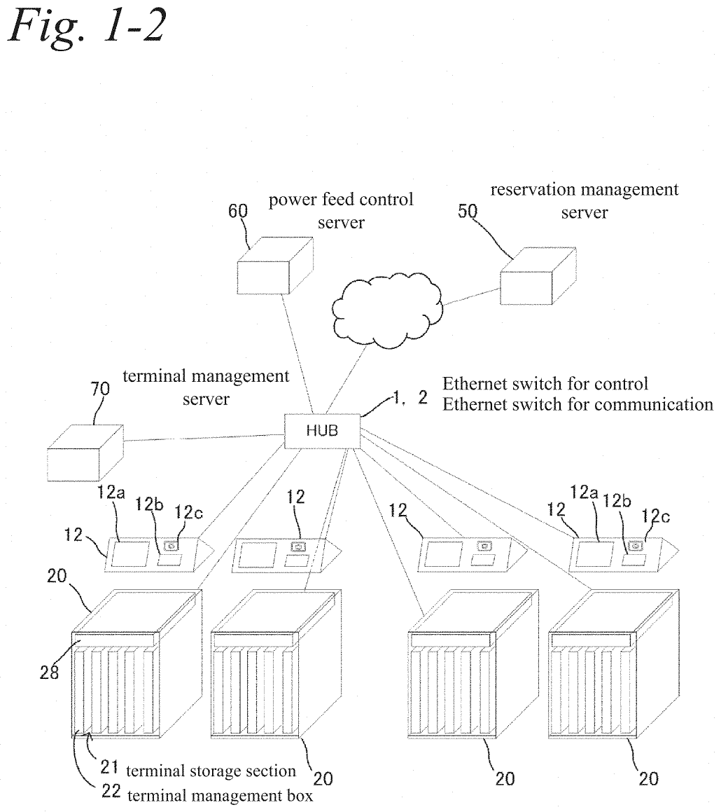

FIG. 1 is an entire configuration diagram of a terminal rental system according to an embodiment of the present invention. In this embodiment, the terminal rental system 10 mainly consists of a terminal rental management device 100 and a terminal locker 20. The terminal rental management device 100 has a reservation management server 50, a power feed control server 60, a terminal management server 70, and other units. It also has a configuration mutually connected to the terminal locker 20 by a local area network through a control Ethernet switch 1 and a communication Ethernet switch 2. Other components, such as a touch panel display 12a, a card reader 12b, a camera 12c for reading QR codes (registered trademark) attached to the terminal C, an operation part 12 with a speaker (not shown) for providing voice guidance functions, and a wireless LAN access point 13 for accessing the Internet, may be provided.

The terminal locker 20 not only functions as a locker to physically store terminals C (lock the terminals to control taking out of the terminals literally), and also individually controls whether the terminal is energized, even when a charging cable is connected, in order to prevent the overload on the power circuit by starting or charging many terminals at once. In addition, the terminal locker 20 makes each terminal be connected to an external network (such as the Internet) via a network switch and also to be connected to the reservation management server 50, the power feed control server 60, the terminal management server 70, and other units via the network.

The terminal rental management device 100 shown in FIG. 1 illustrates that all servers (i.e., the terminal management server 70, power feed control server 60, and reservation management server 50) seem to be installed near the terminal locker 20 (physically within the local area network). However, if sufficient network bandwidth and reliability can be ensured, the servers may be installed in a different place from the terminal locker, such as in the cloud or at other locations.

### Terminal Locker

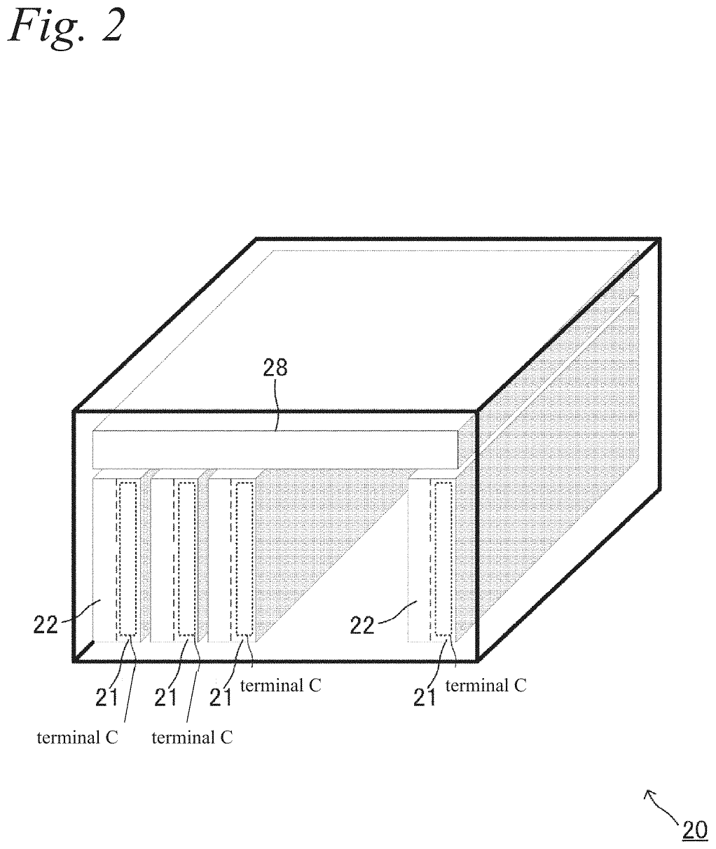

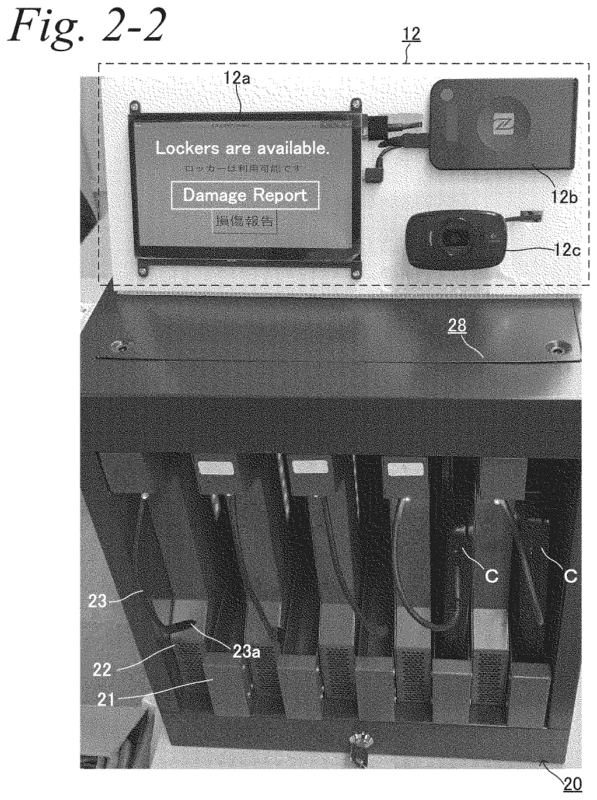

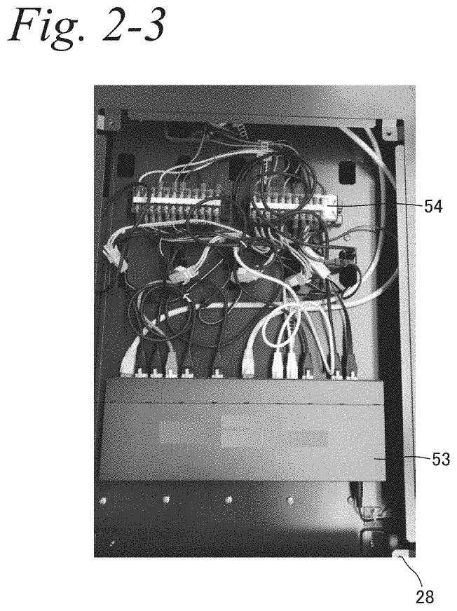

FIG. 2 is a schematic configuration diagram of the terminal locker 20. The terminal locker 20 is a device for storing terminals C inside and includes a plurality of terminal storage sections 21. In addition, a terminal management box 22 is provided adjacent to the terminal storage section 21. Furthermore, one terminal locker controller 28 is associated with each terminal locker 20, but alternatively, one terminal locker controller 28 may be configured to control a plurality of terminal lockers 20. The terminal locker controller 28 plays a role of a distribution board that distributes power to feed each terminal and a switching hub where LAN is branched. Both the branched LAN cable and the power line are sent to the terminal control box 22 and are combined into a single cable to be connected to the terminal.

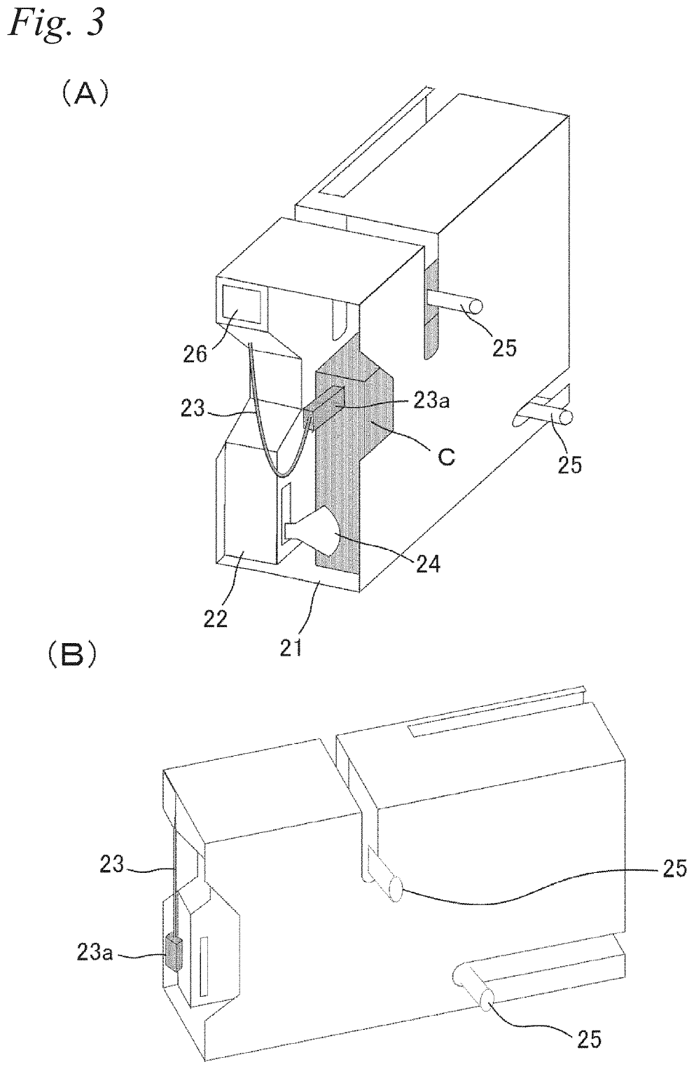

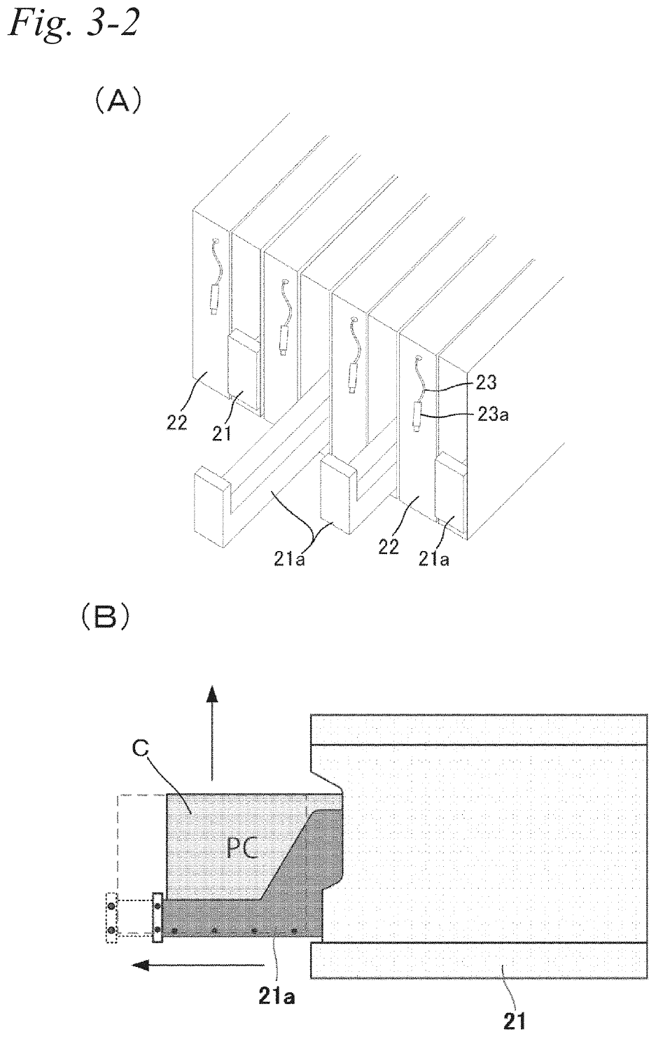

FIG. 2-3 is the terminal locker controller 28 photographed with the top plate removed of a prototype of the terminal locker 20. The device seen on the lower part of FIG. 2-3 is the switching hub 53, and a distribution board 54 is mounted in the upper part of FIG. 2-3. One switching hub 53 plays a role of both the Ethernet switch 1 for control and the Ethernet switch 2 for communication shown in FIGS. 1 and 1-2. In an example, the size of the prototype terminal locker 20 measures about 900 mm wide, 450 mm high, and 450 mm to 500 mm deep.

FIG. 2-2 is a photo of the prototype of the terminal locker 20, taken from above the front. An operation part 12 including a display 12a, a card reader 12b, a camera 12c, and other units is provided on the top plate of the terminal locker 20, and a speaker (not shown) is connected to the terminal locker 20.

The number of the terminal lockers associated with a single terminal locker controller 28 is an important factor to allow more users to efficiently rent the terminals in a short time. This is because if too many terminals are stored in a single terminal locker, users may have to wait in line to rent or return them.

### Terminal Management Box 22

For example, public lockers used in train stations or other locations can be charged by IC card authentication, and each locker requires a key, a sensor for the key, and cables (referring to signal lines mainly for sensors and LEDs or for key control signals or the like). In the case of such a typical locker, at least 10 (five pairs of) cables are required for each locker for one person, and lockers (cables) are commonly installed in groups of 20 or 50 people each. To avoid the complexity of wiring caused by such many cables, a “terminal board”, which distributes the various signal lines to many terminals, is generally used to consolidate and organize the signal lines. However, even if the terminal board is used, many signal lines are still disadvantage, and it may impair maintainability and increase costs.

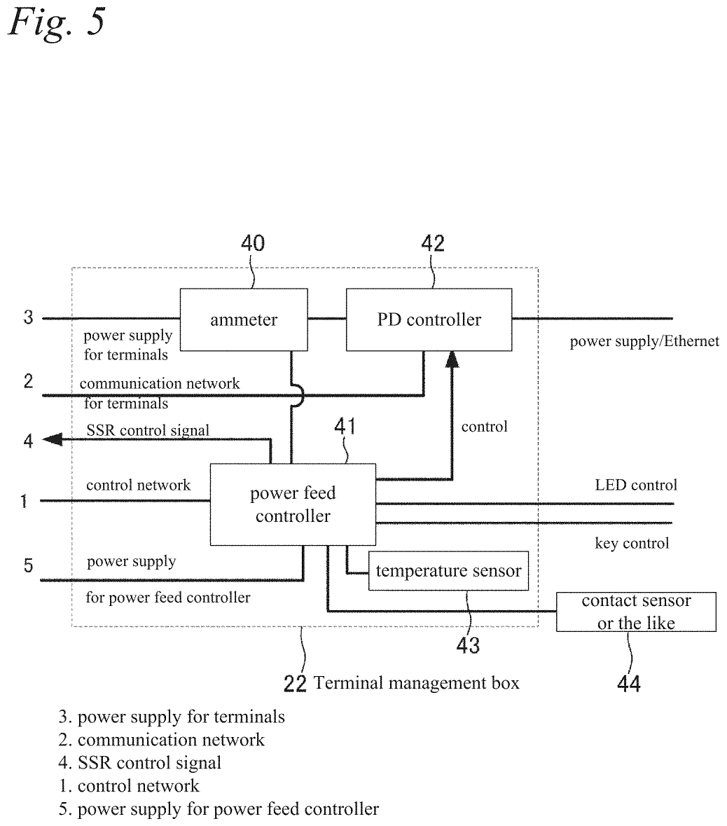

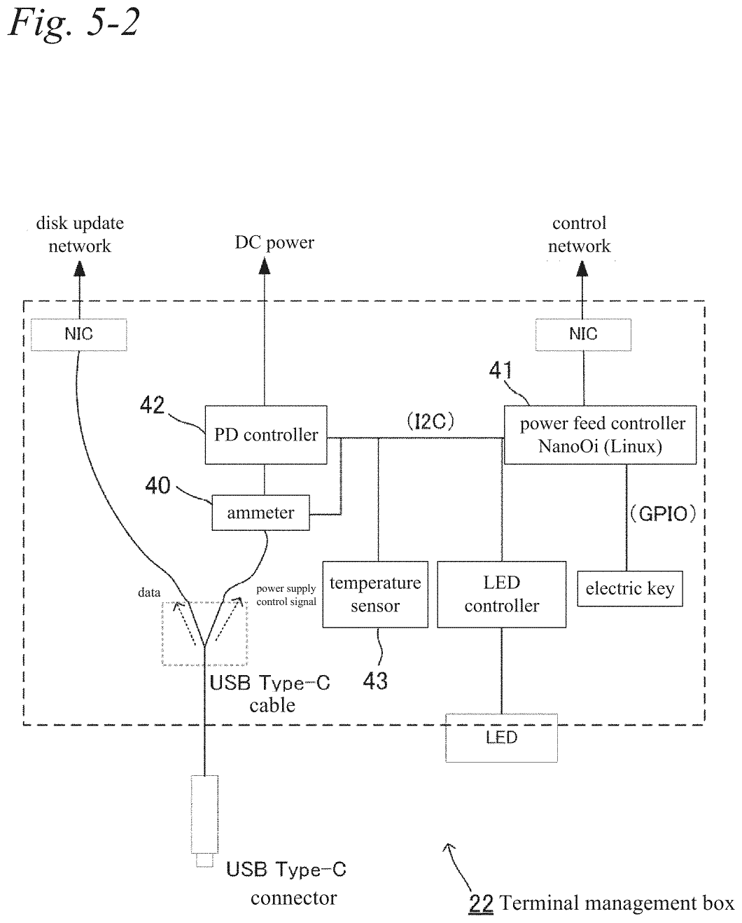

In the embodiment of the present invention, it is configured that one terminal management box 22 is prepared for each terminal and each terminal does not require the consolidation of signal lines by a terminal board. The configuration of the terminal management box 22 will be described below with reference to FIGS. 5 and 5-2. Using the terminal management box 22 to control each locker can eliminate the terminal board and increase the flexibility of the configuration. Since the terminal board is unnecessary, the terminal management box 22 can also be configured greatly simple. In addition, such a configuration can eliminate need for the terminal locker controller 28 to have any functions other than distributing the power supply and LAN and enables the power feed control server 60 to control the terminal management box 22 directly via the network (LAN), and thus, the functions of the power feed control server 60 and the terminal locker controller 28 can be advantageously separated.

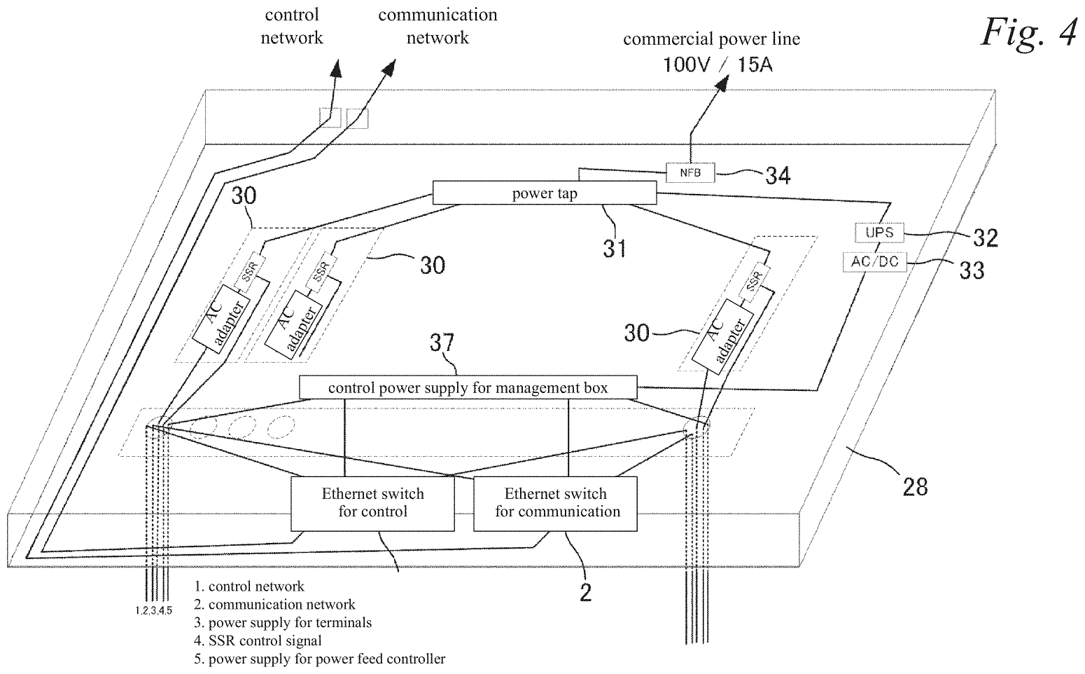

FIG. 4 is a schematic diagram for illustrating the configuration of the terminal locker controller 28.

The terminal locker controller 28 is provided with a power tap 31, UPS 32, AC/DC converter 33, NFB (No Fuse Breaker) 34, Ethernet switch for control 35, Ethernet switch for communication 36, control power supply for terminal management box 37, and power supply circuit part 30.

The power supply circuit part 30 is a power supply circuit to supply power to the terminal C through each terminal management box 22, and the AC adapter coming with the terminal at time of purchase can also be used. Alternatively, one or more dedicated power supply circuits may be provided in the terminal locker controller 28 to distribute and supply power to each terminal management box 22. The terminal locker controller 28 mainly plays a role to deliver the power line and LAN wiring to all the terminal management boxes 22, and thus the power circuit may be installed outside the terminal locker controller 28.

The power supply circuit part 30 preferably has a relay circuit such as Solid State Relay (SSR) in series with the power supply circuit.

Placing a relay circuit such as SSR in the power supply circuit has the advantage of suppressing the inrush current when the commercial power supply is connected.

On the other hand, since supplying power uniformly to all terminals may result in heat generation or over-capacity of the power supply circuit, it is necessary to switch the power on/off for each terminal while observing the power states of the terminals. This control is not performed by the “terminal locker controller 28” associated with the plurality of terminals but by the power feed control server 60 through each terminal management box 22 adjacent to the respective terminal storage sections 21. Advantageously, the terminal management box 22 can remotely start terminals using the Wake on Power Supply function, even if the terminals cannot be started via Wake on LAN (WoL) over the network. The configuration and operation of the terminal management box 22 will be described below with reference to FIG. 5.

All cables in the terminal locker controller 28 (1. control network, 2. communication network, 3. power supply for terminals, 4. SSR control signal, 5. power supply for power feed controller) are connected to the plurality of terminal management boxes 22 (FIGS. 2 and 3), which are placed directly under the terminal locker controller 28, and both 2. communication network and 3. power supply for terminals are connected to the terminals through cables 23.

The power supply circuit part 30, shown with dashed lines in FIG. 4, is located adjacent to the terminal locker controller 28. In this embodiment, the power supply circuit part 30 is located at the bottom of the terminal locker controller 28, and the plurality of terminal management boxes 22 are located directly below them. The control power supply for terminal management box 37 is a DC power distribution circuit for power distribution, and the power feeding to the various switching hubs (Ethernet switches 1 and 2 for control and communication) and the units in each terminal management box 22 (power feed controller, electric lock, and other units) fed from this is backed up by UPS 32. According to the configuration of this embodiment, key management can be performed for a certain period of time even in the event of a power failure. Although the Ethernet switch for communication 2 rarely needs to be connected to the UPS 32, this connection allows the power supply input part of the Ethernet switch for communication 2 to extract DC power within the terminal locker controller 28 and is the only way to extract DC power.

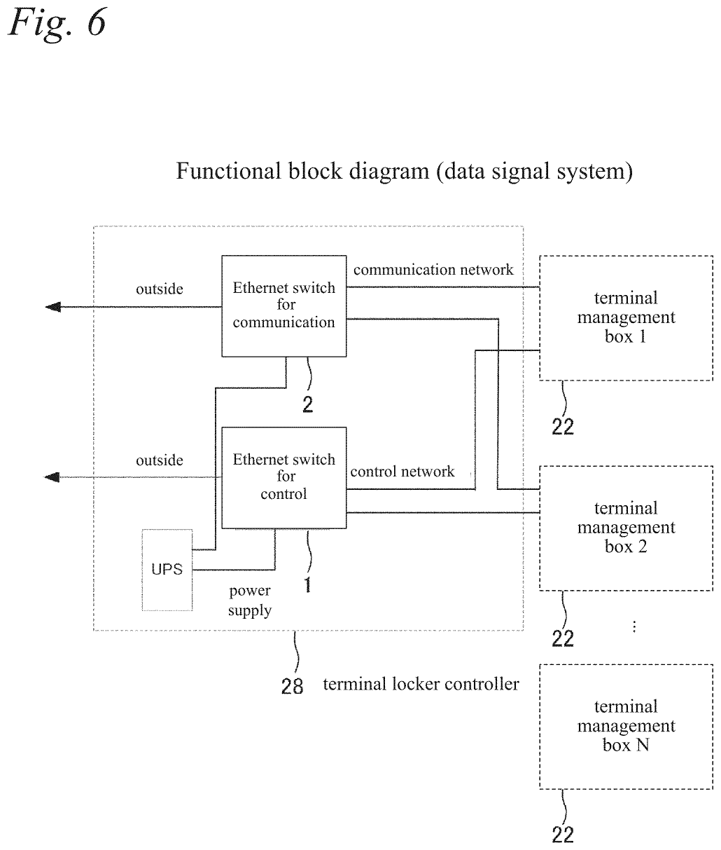

FIG. 6 is a functional block diagram for the data signal system of the terminal locker controller 28. It illustrates that each terminal management box 22 is respectively connected to the Ethernet switch for control 1 and the Ethernet switch for communication 2.

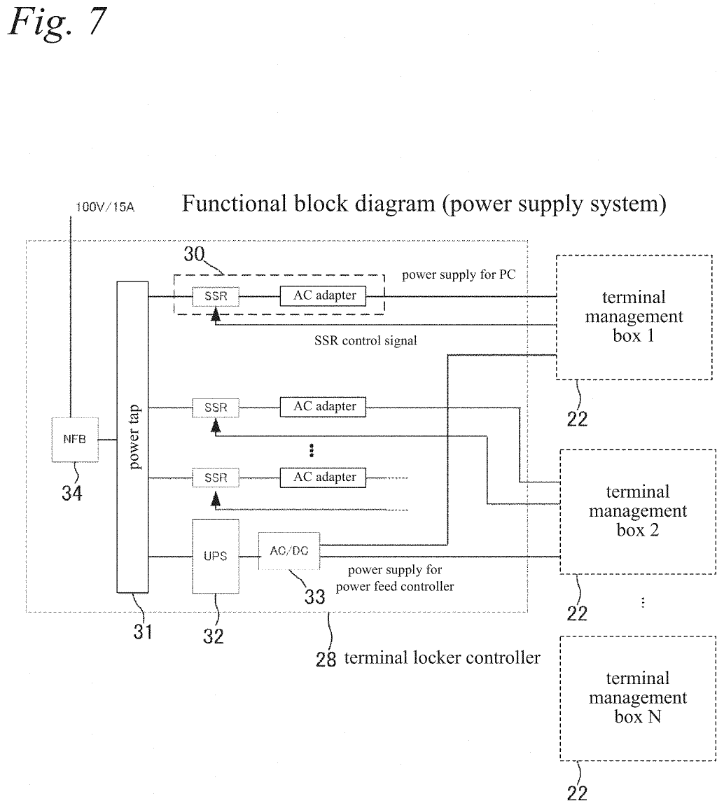

FIG. 7 is a functional block diagram of the power supply system of the terminal locker controller 28. The power supply branched by the power tap 31 is converted to DC power through the power supply circuit part 30 and is sent to each terminal through each terminal management box 22. The determination whether to energize is made on the basis of the relay control signal (SSR control signal) sent from the terminal management box 22 (specifically, the power feed controller 41 described below).

### Terminal Management Box 22

FIG. 5 is the functional block of the terminal management box 22. The left side of FIG. 5 illustrates the five power or data lines that are connected to the terminal locker controller 28. The reference numbers of the signal lines in FIG. 5 correspond to those of the five cables shown in FIG. 4 (1. control network, 2. communication network, 3. power supply for terminals, 4. SSR control signal, 5. power supply for power feed controller).

An ammeter 40 is connected to the terminal power supply line 3 supplied from the power supply circuit. The ammeter 40 is connected to the power feed controller 41, and the measured values are sent to the power feed controller 41. The power feed controller 41 is a so-called IoT control device (e.g., microcomputer) with Linux (registered trademark), embedded OS, or the like built in and given an IP address, and it is used to control the power feeding to the terminal C stored in the terminal storage section 21 located next to the terminal management box 22. It also exchanges the data necessary for control with other terminal management boxes and various servers through the control network (signal line 1). The PD controller 42 controls not only the energized state of the terminal C but also the interface of the terminal C.

The charge state of terminal C to which the charging cable is connected is examined, and the power consumption required to start terminal C is calculated on the basis of the examination. Each terminal management box 22 has its own power feed controller 41, and each power feed controller 41 is assigned an IP address. The power feed control server 60 can start the terminal C through the PD controller 42 and examine the power consumption to obtain the charge state of the terminal C. The states of all terminals can be examined and assessed through all terminal management boxes 22, and thus the power consumption of terminals C can be controlled as a whole system. In this way, the power feed control mechanism is configured to start power feeding after determining whether to start power feeding on the basis of the maximum power that each terminal may consume when being started. Charging to terminal C will start, only when power is fed to the cable connected to terminal C and a checking mechanism on the terminal side determines that charging is necessary.

It is preferable to start power feeding of terminal C conditional on both “being energized under the control of SSR” and “PD controller 42 being set to feed power.” It is because the main purpose of the former is “preventing inrush power supply at the time of connection to commercial power supply” and that of the latter is “preventing total power consumption from exceeding a predetermined value”, and thus the content and purpose of each control are different. The feeding power is controlled not to exceed the maximum feeding power according to the determination by the power feed control server 60, which permits or rejects the request of the power feed controller 41.

The main role of the power feed controller 41 is as described above. Furthermore, when a terminal C is returned to the terminal storage section 21, the power feed controller 41 may be configured to control the terminal storage section 21 so that the terminal storage section 21 cannot be locked until the terminal storage section 21 detects that the connector 23a at the end of the cable 23 has been properly connected to the terminal C. In this way, the user will not accidentally forget to connect the cable or fail to properly connect it. Similarly, when the terminal C is rented, i.e., when the terminal C is taken from the terminal storage section 21, it also may be configured so that the terminal storage section 21 cannot be unlocked until the terminal storage section 21 detects that the cable has been properly removed from the terminal C. If the terminal storage section 21 is unlocked before the cable has been removed, the cable may be damaged. However, this configuration can prevent such human error.

The power supply line 5 shown in FIG. 5 is a DC power source supplied from the control power supply for the terminal management box 37 and is a power line for supplying power to the power feed controller 41.

Either the terminal storage section 21 or the terminal management box 22 may be provided with a temperature sensor 43 to monitor the temperature of the terminal C or a contact sensor 44 to detect whether the terminal C is stored in the proper position.

The terminal management box 22 may be provided with a locking mechanism 24 enabling the taking out of the terminal C to be controlled, movable bars 25 (25a, 25b) to adjust the depth and height according to the size of the terminal C, and an information display 26 to display various information about the terminal C stored in the adjacent terminal storage section 21 (e.g., charge state, update state, reservation status, etc.).

### Configuration Example

FIG. 5-2 shows an actual configuration example of the block diagram shown in FIG. 5. In the case of USB-Type C, the data is represented as Tx/Rx and D+/D−, the power is represented as Vcc, and the control signal is represented as CC1/CC2. The LED is mounted on a board or the like inside the terminal management box 22, but a light-emitting part is exposed from the housing of the terminal management box 22 and placed to be seen from outside. In an example, the LED is placed on the border of the terminal management box 22 in FIG. 5-2.

The power feed controller 41 in FIG. 5 is configured using a small board computer called NanoPi in FIG. 5-2, and Linux (registered trademark) as well as a network interface capable of high-speed communication have been installed, thereby functioning as the power feed controller 41. The configuration shown in FIG. 5 is the initial design and the ammeter 40 is placed on the DC power supply side, and that shown in FIG. 5-2 is the prototype design and the ammeter 40 is placed on the Type C cable side. In FIGS. 5 and 5-2, the ammeters 40 are placed on different locations, but both of the configurations are for measuring the current flowing into the power feed controller 41 and controlling the feeding power through the PD controller, and one of the configurations will be adopted.

### Terminal Storage Section 21

When the terminal C is stored in this terminal storage section 21, terminal storage section 21 can be put into a locked state, i.e., the state where the terminal C can be controlled from being taken out. As described above, the “terminal C” can be any “computer with a battery and easy to be carried around”. The typical example would be a laptop computer or tablet. At least one terminal locker 20 is required for one terminal rental system 10 in a single location. The number of terminals that can be rented in the single location can be increased if more lockers are mounted as shown in FIG. 1. In addition, the cable 23 for charging and for distributing the disk image of the operating system or its update data is arranged from the terminal management box 22 to the terminal storage section 21.

FIG. 3(A) is a perspective view of the terminal storage section 21 of the terminal locker 20 where the terminal C is stored. As shown in FIG. 3(A), the terminal management box 22 is placed adjacent to each terminal storage section 21. The terminal storage section 21 corresponds to the terminal management box 22 one-to-one basis, and thus the number of them are also the same. In this way, it is easy to clearly indicate where the cable 23 should be connected within the terminal C, for example, by placing a sticker on the terminal management box 22, making management easier. A configuration in which the cable 23 is suspended from the top of the terminal management box 22 and the connector 23a on the end of the cable 23 is connected to the terminal C may be adopted.

FIG. 3(B) is a perspective view of the terminal storage section 21 where the terminal C is removed (i.e., being rented). As shown in FIG. 3(B), when the connector 23a has been removed from the terminal C, the cable 23 can be left hanging down from the upper part of the terminal management box 22. Such configuration prevents the cables 23 from getting in the way even when the plurality of terminal storage sections 21 are provided, and is easy to be used. Alternatively, the cable 23 may be of the rewind type.

In an example, the cable 23 preferably has an interface based on the “USB 3.1 PD” standard, which is connected with a “USB-Type C” type connector 23a. This interface allows for both charging and bi-directional data communication, and thus the charging cable and data communication cable (e.g., LAN cable) do not need to be connected separately. In other words, this cable is preferably a cable connected to USB 3.1 PD or its higher compatible one or a similar single interface allowing for both charging and data communication, such as a USB-Type C cable (hereinafter referred to as “USB-C cable”).

The letters “PD” of the “USB 3.1 PD” interface stand for each first letter of Power Delivery, and the maximum power profile of USB-PD can provide up to 100 W (typically 20V/5 A), supporting fast charging. In addition, it is possible to efficiently and sequentially charge terminals to be managed while monitoring their charge states and the number of terminals being charged.

With the USB 3.1 PD interface, the terminal can be turned on through external control, and the operating system also can be booted. In addition, data communication with the outside is also possible after the operating system is booted. Above all, with a single cable connection, the terminal C can charge and the operating system or the like can be updated, which are required for the next rental, while the terminal C is stored.

When each user finishes using the terminal, the state of the hard disk has been usually changed from the state when the terminal was rented. If the operating system of each terminal is patched or security software is updated in such a state, the state of each hard disk will be different for each terminal. For above reason, “update” shall include restore operations. Examples of the operation include deleting data that the user was added while using the terminal before the update.

The terminal without a USB 3.1 PD Type C cable may need to be respectively connected to a cable for charging the battery and another cable for connecting to an interface for data communication or the like (e.g., LAN cable). After the terminal is started, the terminal can be shut down through the remote connection after necessary operations (such as updating the operating system) are completed. However, in order to turn on the power at any given time via remote access from outside, setting Wake on LAN, etc. is required, and at least two cables (power cable and LAN cable) must be connected. Furthermore, the charge state can be monitored only when the operating system is running, and thus this can be feasible but inefficient. External interfaces, such as USB 2.0 and e-SATA, may be expected for data communication, but these interfaces cannot be used to turn on the power in general and need to ask the user a lot of tasks, such as connecting cables, and thus this cannot be practical.

### Improvement on Terminal Storage Section 21

At the time of development, the external shape of the locker for storing the terminal C was assumed to be as shown in FIGS. 2, 3(A), and 3(B), but in this configuration, the first operation for taking the terminal C out from the housing is a one-handed operation of “pinching and pulling out the terminal C,” which is not that the terminal C is handled carefully with both hands. If the user pulls the terminal C out with one hand, the user only unsteadily pinches the terminal with fingertips. Then, the downward force of the full load of the terminal C will be applied at once to the fingertips when the terminal C comes out of the housing. In this case, the user may drop and damage the terminal C.

To avoid such a problem, the system has been improved into a rail type as shown in FIGS. 3-2(A) and 3-2(B).

FIG. 3-2(A) is a schematic configuration diagram of the terminal storage section (only) with improvements added, and FIG. 3-2(B) is a view of the terminal storage section 21 with a terminal tray 21a pulled out.

In other words, a plurality of rail type trays are provided in the housings of the terminal locker, which can be locked when the rail is contained in the housing. According to this configuration, when taking a terminal C out from the locker, the user is naturally encouraged to perform a “two-way” operation: pull the rail out horizontally as the first operation, and then lift the terminal C with both hands firmly holding it as the second operation.

### Reservation Management Server

The reservation management server 50 manages the rental reservation information for the terminal C stored in the terminal storage section 21. For example, not only the information necessary for reservation management is obtained from users via the Internet, but also the system calculates the date and time when the terminal can be rented on the basis of the information regarding the charge state of each terminal obtained in the terminal locker 20, and the progress of the distribution of the disk image of the operating system or its update data to each terminal.

In the present invention, “reservation management” can include not only the reservation operation for renting the terminals, but also user authentication when the terminal is rented and the processing operations when it is returned. Conversely, the case where the “number of remaining terminals” available for being rented is only managed is also considered as “reservation management.” The “reservation management server” also refers to a system providing a mechanism for authenticating users when the terminal is rented, and it does not necessarily need to be operated over a network such as the Internet or an intranet. When the user reserves the terminal on the spot and the available terminal is rented immediately, then the system simply authenticates the individual on the spot. User authentication can be performed with an existing authentication system, such as an IC card (e.g., a student ID or transportation card) authentication system using NFC (Near Field Communication) technology that has been already common, or users can be authorized by a username and password. However, with authentication using only the IC card, the case where the user is authenticated by another person's IC card is not supported, and thus a known multiple authentication method, such as adding authentication by password or email/short message in advance, can be used to increase security.

As to “reservation management,” it is extremely important to manage “the person who rented the terminal” when the terminal is rented. However, it is important to manage the state that the terminal has been returned but not necessarily important to manage “the person who returned the terminal” when the terminal is returned. In other words, the system can be designed to authenticate the user at the time of being rented and identify the terminal at the time of returning. For example, a QR code (registered trademark) can be attached to the surface of the terminal, and a QR code (registered trademark) reader is introduced on the operating terminal or the like of the locker to identify the terminal. Whoever returns the terminal, this configuration can at least identify which of the rented terminals has been returned. The user does not need to carry the IC card when returning the terminal or can ask someone else to return it. In this way, there can be asymmetry between personal authentication and terminal identification when the terminal is rented and returned. As described above, QR code (registered trademark) can be used as a mechanism to identify terminals. It also can be configured to attach something like a tag to the terminal or to read the barcode with an infrared sensor, and any mechanism to identify terminals can be used and can be known methods. In this case, the “reservation management server 50” is provided with a mechanism to authenticate individuals (e.g., IC card reader) and a mechanism to identify terminals (e.g., QR code (registered trademark) reader). In order to allow many users to efficiently rent and return the terminals, the above mechanisms are preferable to be prepared for each terminal locker 20 or for a small group of terminal lockers. The “reservation management server” does not need to consist of only one server, and the configuration where the reservation management server and an operating terminal for personal authentication and terminal identification at the time of reservation are installed in each locker can be included.

### Guidance Function

In this system, to unlock the terminal and take it out from the terminal locker 20 when the terminal is rented, the user needs to unplug the cable 23 connected to the terminal C and then pull the terminal out from the locker to take the terminal. When returning the terminal, conversely, a relatively laborious series of operations are required, such as identifying the terminal, pulling out the rail to place the terminal, pushing the rail back into the locker to lock it, and then connecting the cable 23 to the terminal C. In the preferred embodiment of the system, the cable 23 is simple since a single USB-Type C cable that combines charging and data communication functions is used as mentioned above. However, when the user uses the locker where the plurality of terminals C stored side by side, it should be avoided that he/she accidentally connects adjacent different cable 23 to the terminal. Thus, it is preferable to prepare a mechanism that appropriately guides the first-time user through the following operation procedure.

According to the embodiment of the present invention, the reservation management server 50 is provided with a voice guidance function that guides the rental and return operations of the terminals by voice, and one or more light-emitting parts that light up, turn off, or flicker are mounted in each terminal storage section 21. The individual is authenticated when renting the terminal, and thus the language and voice can be pre-selected to the user's preference for voice guidance, making the system more user-friendly. In addition, the flashing of the light-emitting part worked with the voice guidance can prevent users from being confused during the rental and return operations. In particular, the user needs to be careful the most about the following two points when returning the terminal: (1) properly returning the terminal to the terminal storage section; and (2) properly connecting the cable to the terminal.

In the above points, the voice guidance and flashing of the light-emitting part can guide users on how to advance the procedure properly. Furthermore, the light-emitting part can also indicate the status of the terminal (charging, under maintenance, available for being rented). The above configuration allows for unattended rental and return management of a plurality of terminals in a short period of time, and also provides an easy-to-understand interface that accurately instructs the user what to do next to rent the terminal.

There is one more point that should be considered for guidance when the terminal is returned. According to the present system, the user can return the terminal to the different locker that is not the locker from which the terminal is rented in theory. However, as in the case of rental bicycles that can be ridden away, the terminals can be unevenly returned to some particular locations if too much freedom is allowed for the return policy, and it can increase the burden on the system provider to relocate them. Consequently, an operation allowing the user to choose a different return location among neighboring lockers to some extent, for example, the lockers located near the locker where the user rented the terminal can be a beneficial system for both users and the system administrator.

On the other hand, according to the present system, different sized terminals (e.g., 13 inches, 15 inches, etc.) can be mixed and stored in the same housings of the locker, because the method for charging the terminals and for the operating system maintenance does not need changes even if each terminal size is different. However, from the standpoint of theft prevention, lockers that store smaller sized terminals naturally need to have adjusters or other metal fittings to prevent unauthorized taking out of the terminals when the locker is locked. However, when the user returns the terminal to a different locker from the one when the renting it, the adjuster does not fit and the terminal cannot be returned even though there is room, causing the user inconvenience. To solve such problems, voice guidance and light-emitting parts are particularly useful in directing users to nearby lockers where they can return the terminal.

### Power Feed Control Server

The power feed control server 60 provides the function for controlling the feeding power to the terminal C not to exceed the maximum feeding power to the request of the power feed controller 41. It also has the function to manage the locking status of the terminal storage section 21 on the basis of the rental reservation information, the charge state of the terminal C, and information relating the distribution state of the disk image or its update data. In addition, the power feed control server 60 examines and assesses the states of all terminals through all the terminal management boxes 22 and controls the power consumption of terminals as a whole system.

The power feed control server 60 can also be further provide a function to manage the locking status of the terminal storage section 21 in the terminal locker 20 by issuing control signals or the like to control the locking mechanism 24 provided in the terminal management box 22.

In the USB-PD interface standard described above, when a cable is connected, the PD controller 42 and terminal C mutually perform authentication and negotiation with each other to examine and determine information such as “which side will be the power supply side and which side will be the power receiving side” and “voltage value and current value while feeding.” In other words, the power consumption during charging is not determined according to the AC adapter built in the terminal but the result of mutual communication based on the USB-PD standard when the cable is connected. In the present invention, for example, when a terminal locker is set to be allowed to consume 500 W as a whole and eight terminals have already started power feeding with the setting that each consumes 60 W, the negotiation is performed on the ninth terminal before feeding, for example, “15 W (5V/3 A) can be used for feeding.” Some settings for the power value have been predetermined in advance, and it is not configured to be able to extract any power value for feeding. Examples include adapters with settings such as “5V/3 A (15 W), 9V/3 A (27 W), 15V/3 A (45 W), 20 V/2.25 A (45 W)”. Due to these circumstances, it is assumed that two-step control is performed: “SSR is energized when a request for power allocation is received,”; and “when it is determined that the terminal should be charged (because the terminal may be set to start up just by being energized in some cases, as described above), the controller is controlled to actually feed power.”

In other words, the power feed control server 60 determines whether to give permission to the request of the power feed controller 41 and controls the feeding power not to exceed the maximum feeding power.

### Terminal Management Server

The terminal management server 70 distributes the disk image of the operating system and its update data to the storage (hard disk, SSD, or other units) of each terminal C stored in the terminal storage section 21. The update data refers to data that has been changed to the storage, such as differential data from the original disk image or incremental data after the last time that the terminal was rented. The update data includes data created by the user during been rented, operating system updates (security updates), virus pattern data updates for security software, and any other change data to the storage of each terminal, such as application software added or updated. Updates also include “restoration.”

When the terminal management server 70 is used to distribute the update data, at least one terminal management server 70 is preferably installed at each location. However, the terminal management server 70 may be installed at a different location, such as in the cloud or at another location if sufficient network bandwidth and reliability can be ensured, from the terminal locker. Alternatively, one or more relay servers may be installed in each location to manage more terminals. This kind of scalability allows a feature of the terminal management server 70 to be used as it is. On the other hand, if “only restoration” is required, the terminal management server 70 can be omitted since distribution is not required.

Furthermore, the other servers (reservation management server 50, power feed control server 60) constituting the terminal rental management device may also be installed in a different location, such as in the cloud or at another location, from the terminal locker.

As described above, with the configuration of the above embodiment, the terminal can be charged and the disk image of the operating system and its update data can be distributed without manual intervention, performing rental management and maintenance operations stably over a long period of time.

### First Embodiment

FIG. 1-2 illustrates an exemplified configuration of the present system with a plurality of terminal lockers 20 arranged side by side. In the embodiment, one operation part 12 is provided in each terminal locker 20. The operation part 12 is provided with a touch panel display 12a, a card reader 12b, a camera 12c for reading the QR code (registered trademark) attached to the terminal C, and a speaker not shown in FIGS. for providing voice guidance functions.

The terminal locker 20 includes the terminal storage sections for five terminals. The terminal locker 20 is provided with the same number of terminal storage sections 21 and terminal management boxes 22 arranged side by side as the number of terminals stored. One terminal locker controller 28 is provided per terminal locker 20, and the terminal locker 20 is connected to a reservation management server 50, a power feed control server 60, a terminal management server 70, or other units through switching hubs 1 and 2 via a network.

As described above, the terminal management box 22 includes a power feed controller (41 in FIGS. 5 and 5-2) and communicates with the power feed control server 60 to control feeding, and thus, it allows more terminal storage sections to be configured in principle. However, the terminal locker 20 configured to store too many terminals is, first, expected to cause congestion when the users rent and return terminals. Second, the load will be too large for the power supply capacity, and the power feeding control function may result in long waiting times for charging. The same applies to the network load, which may lead to longer waiting times for maintenance work. Third, a small number of units can naturally be manufactured at a low cost. Comprehensively considering all of these, the actual installation environment, such as the power supply and network and the intended use (e.g., how many terminals will be rented and what kind of usage is supposed) can be designed.

### Second embodiment

The main function of the terminal storage section 21 is to perform rental management operations of terminals C (i.e., to manage the storage and rental of terminals C) without manual intervention, but the rental management operations of terminals C also can be performed through manual intervention. In a usage environment that does not require systematic management of the locking status (e.g., the cases managed manually at the counter can be assumed), “a terminal locker with a terminal storage sections for storing terminals while locking them” and “a locker control server that controls the locking status of the terminal storage section” as described above are not essential. Omitting these configurations has also the advantage of significant cost reduction of the entire system. In this case, a resident janitor or the like is required to manage the rental of terminals C. However, maintenance work only requires plugging and unplugging cables to terminals C, and there is no need for complicated work such as “updating the system,” which requires a high level of expertise and a long time if it is done manually. In other words, the workload on the system administrator's side becomes much smaller.

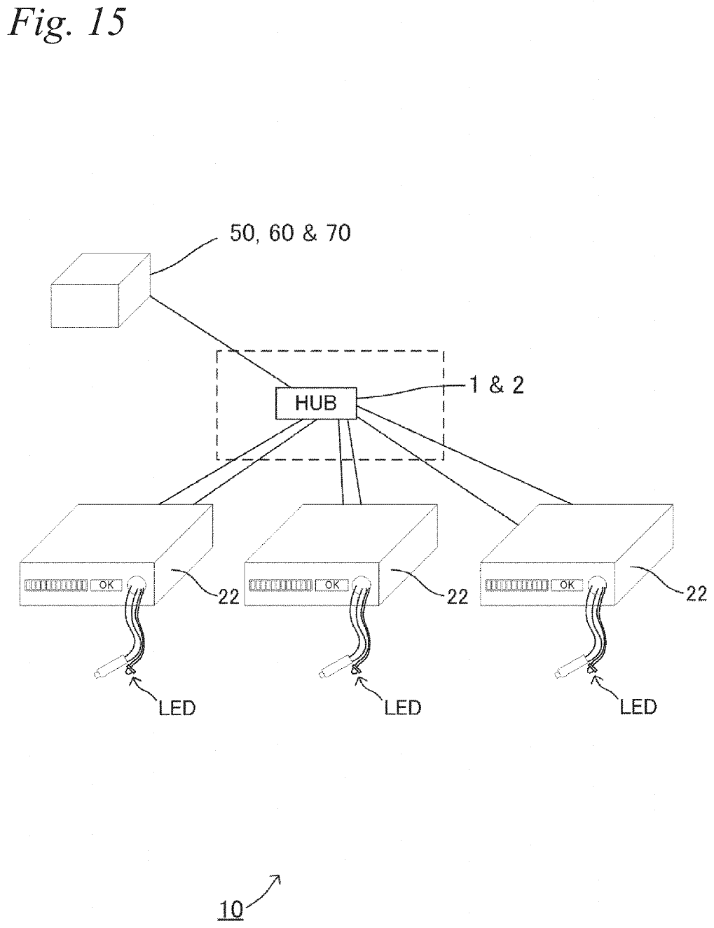

For example, FIG. 15 illustrates another embodiment (second embodiment) of the terminal rental system 10 described in the first embodiment. There is no terminal locker 20, and the various servers (reservation management server 50, power feed control server 60, and terminal management server 70) are integrated into a single server. Furthermore, although a separate configuration of Ethernet switch 1 for control and Ethernet switch 2 for communication is preferred, the switching hubs are used for both control and communication. In this way, unnecessary components are excluded or multiple server functions and switching hubs are integrated according to various purposes, and thus the entire system can be greatly simplified, and the cost can be reduced.

### Second Aspect

The processing flow for each configuration will be described.

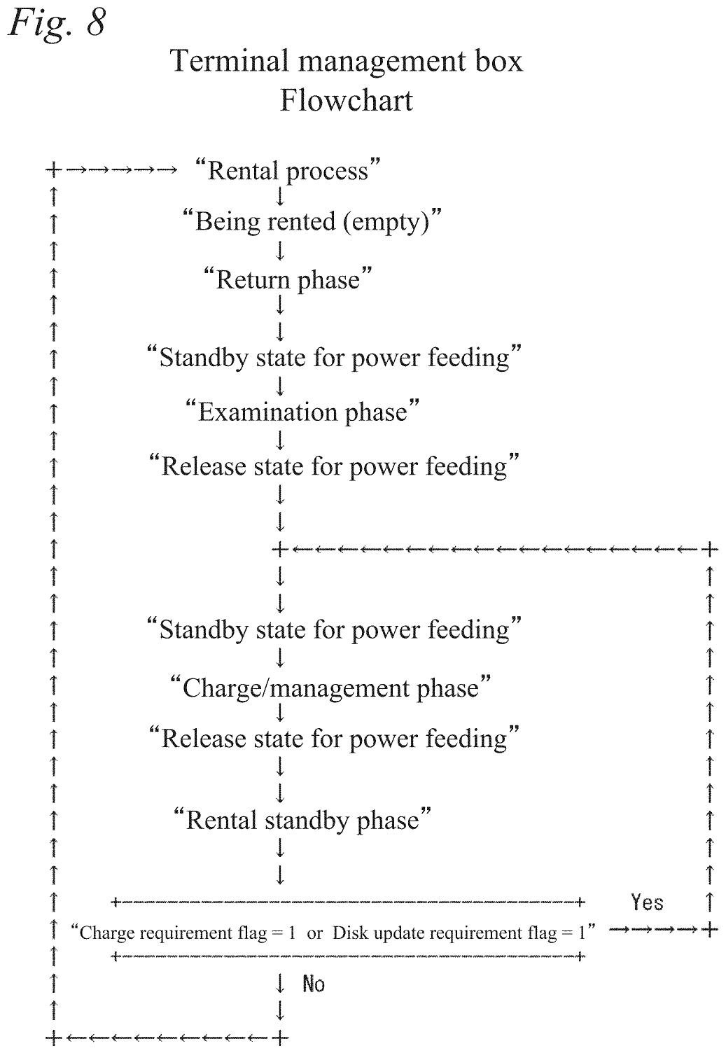

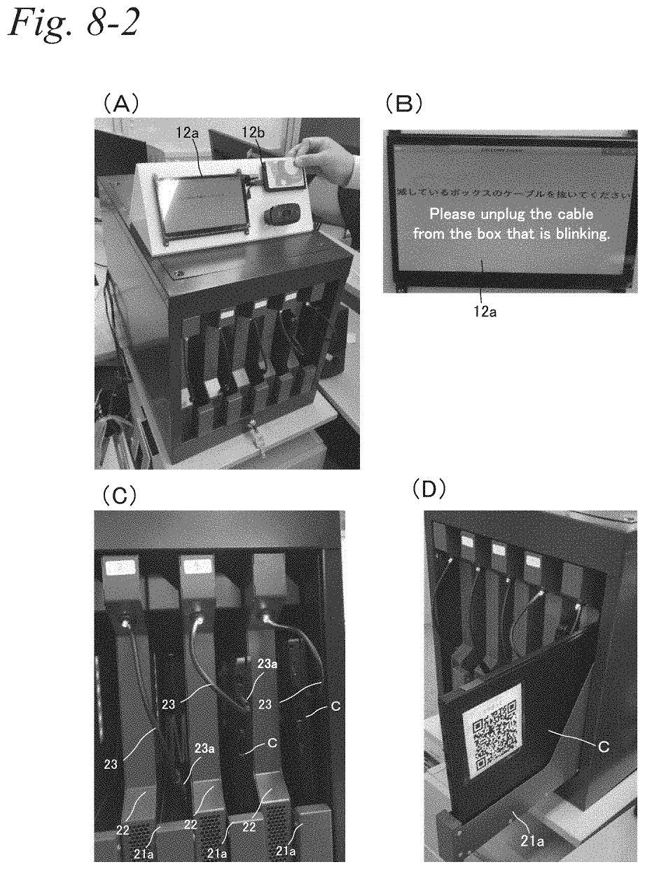

FIG. 8 illustrates the processing flow of the terminal management box 22. In FIG. 8, the terminal C is locked from the end of the “return phase” until it enters the “rental process,” and is powered only during the “examination phase” and the “charging and management phase.”

First, when the rental process is performed, the locking mechanism 24 is activated by a signal from the power supply control server 60 and is unlocked when the cable is removed. During the terminal is rented, the information display 26 shows that the terminal is being rented, and the reservation management server 50 records the terminal as being rented.

Next, when the terminal C is returned to the terminal storage section 21, the phase proceeds to the return phase. The power feed controller 41 first sets the terminal to the standby state for power feeding (stop state of power feed). Then, the power feed controller 41 examines the states of other terminals C for power feeding (examination phase) and then set the terminal (which meet the predetermined condition) to a release state for power feeding. The charge state of terminal C is monitored through the PD controller 42.

An optional feature in the USB 3.1PD interface specification provides the ability to monitor the charge state even when the terminal is turned off. In the return phase when the terminal C is turned off and returned, the charge state is examined directly without turning on the power when the charging state can be detected using this offline monitoring function of the charge state. When the function is not available, the terminal C is turned on and the charge state is examined using the function of the operating system.

If it is determined that charging or updating of the operating system is necessary, the charge requirement flag or the update requirement flag is set to 1 and power feeding is started.

(A) to (D) of FIG. 8-2 are photos illustrating the processing flow of the rental phase. First, the user holds the IC card over the card reader 12b to perform the personal authentication (FIG. 8-2 (A)). As shown in FIG. 8-2 (B), the display section 12a shows guidance for the next operation to the user, and the speaker and the color and flashing of the light-emitting part (both omitted) in the terminal management box 22 are provided so as to prevent the user from being confused in the operation with consideration. When the user pulls off the connector 23a at the end of the cable 23 following the guidance, the terminal C is unlocked and the terminal tray 21a can be pulled out (FIG. 8-2 (C) and (D)).

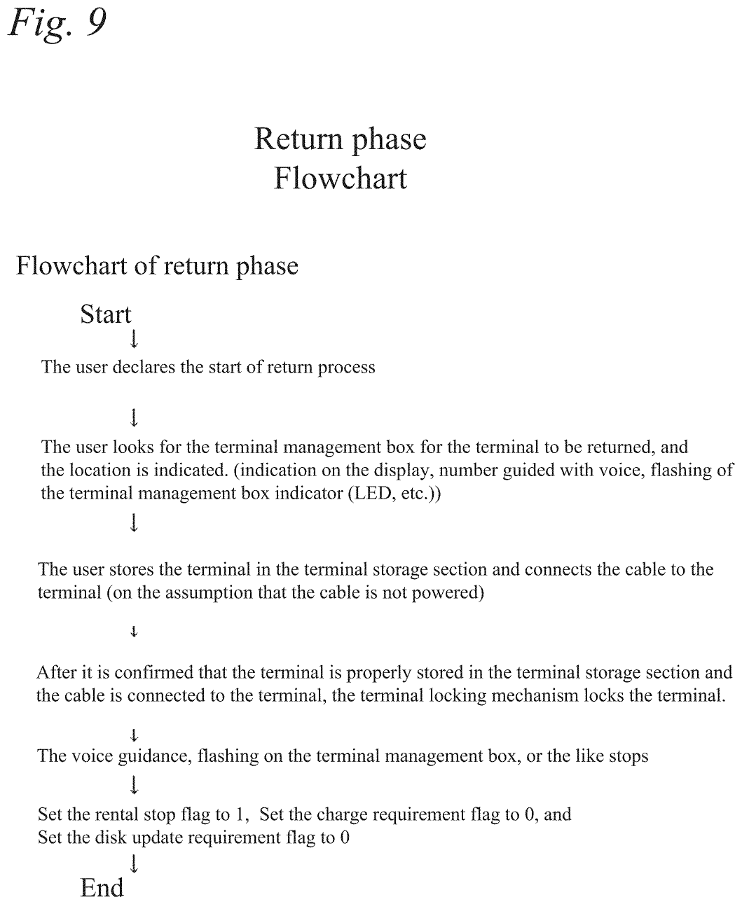

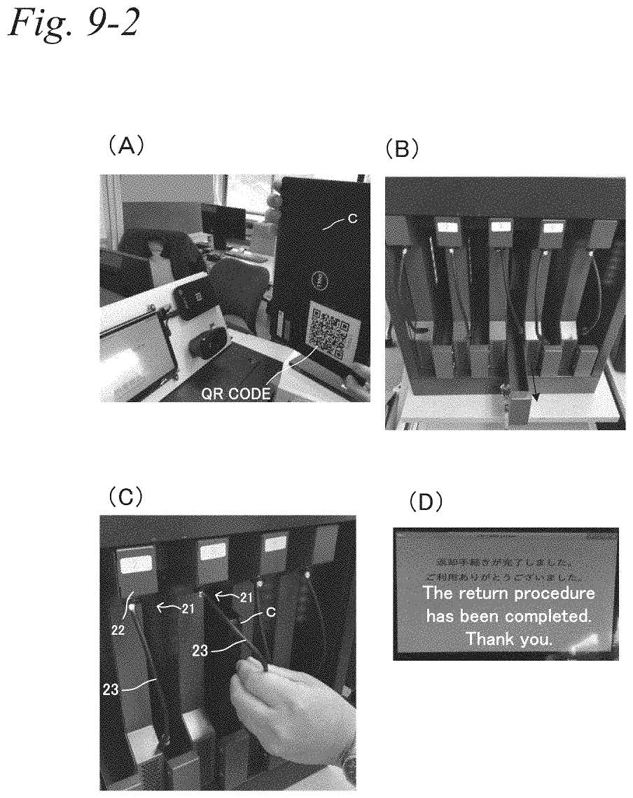

FIG. 9 is a processing flowchart of the return phase. As shown in this processing flowchart, it can be configured that unless the terminal is stored in an proper location and the cable is connected, the locking mechanism of the terminal will not be operated and the terminal will not be processed as having been returned.

FIG. 9-2 is a photo illustrating the processing flow of the return phase. The terminal C is provided with a QR code (registered trademark) attached, which uniquely identifies the terminal when the terminal C is held over the camera 52 of the terminal locker 20. When terminal C is identified, the lock is released, the tray is pulled out in the direction of the arrow, and then terminal C becomes ready for storage (FIG. 9-2 (b)). Next, after returning the terminal C to the tray and pushing the rail back into the terminal storage section 21, the user connects the connector 23a at the end of the cable 23 to the terminal C. Then, the return process is completed, and the display section 12a indicates the process has been completed, and at the same time, the user is also notified of it by voice guidance.

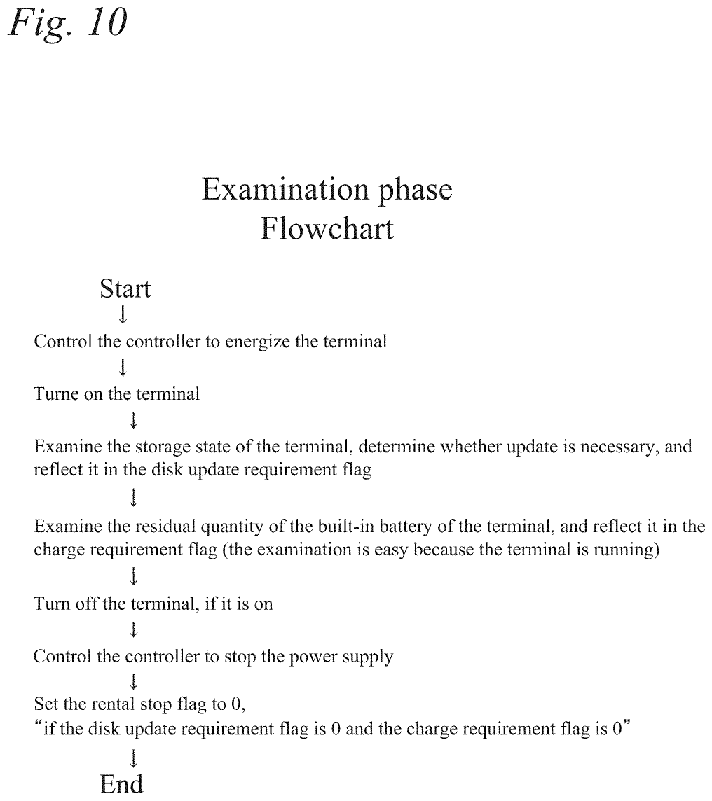

FIG. 10 is a processing flowchart of an examination phase.

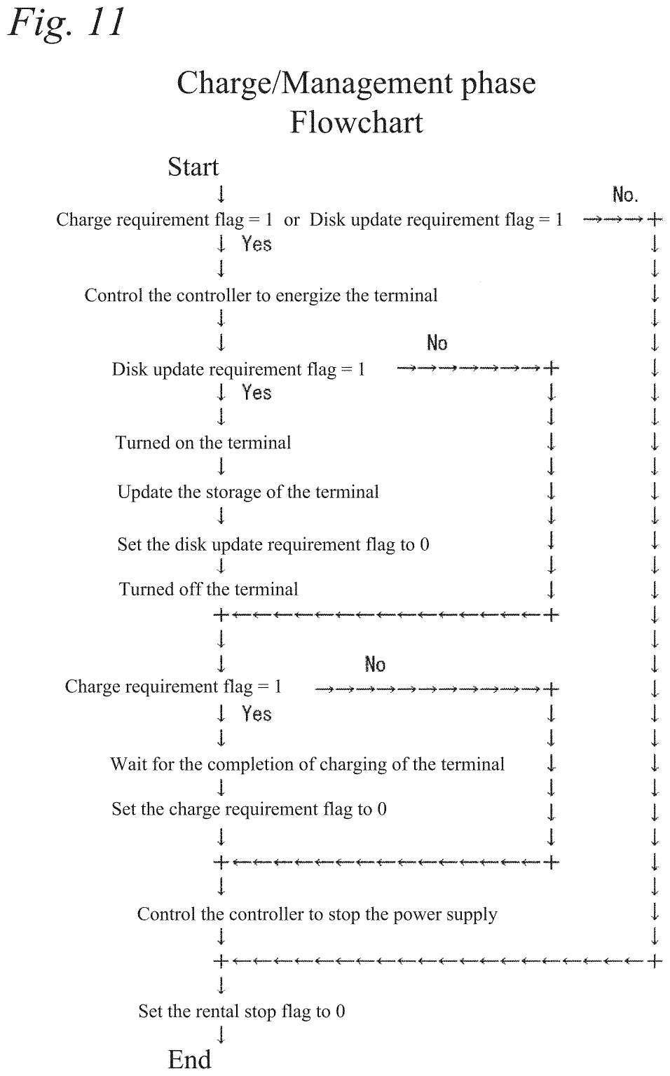

FIG. 11 is a flowchart of a charging/management phase.

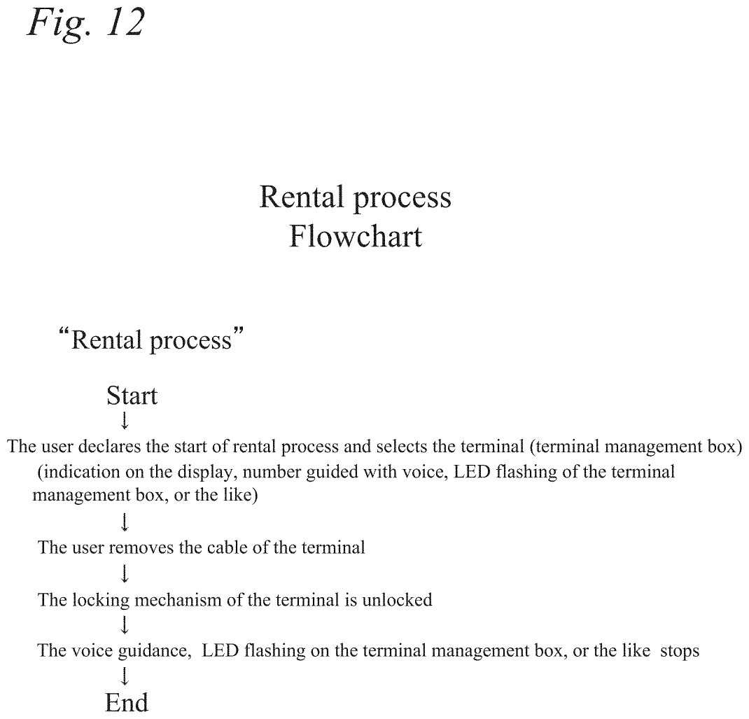

FIG. 12 is a flowchart of a rental processing. In the rental processing, removal of the cable is controlled to be the trigger for unlocking the terminal locking mechanism.

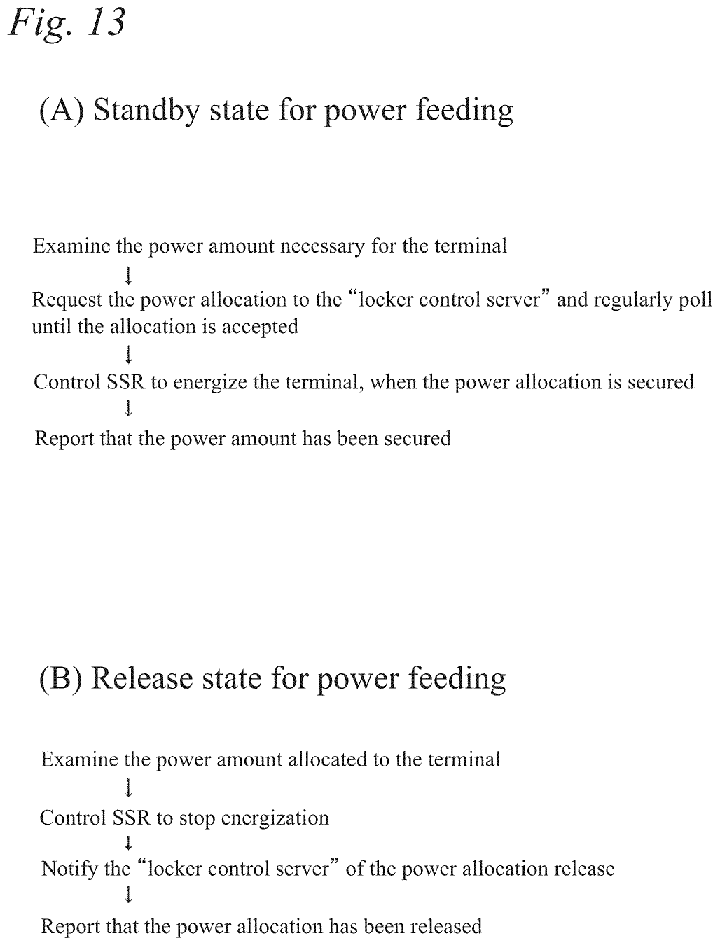

FIG. 13(A) is a processing flowchart in a standby state for power feeding, and FIG. 13(B) is a processing flowchart in a release state for power feeding.

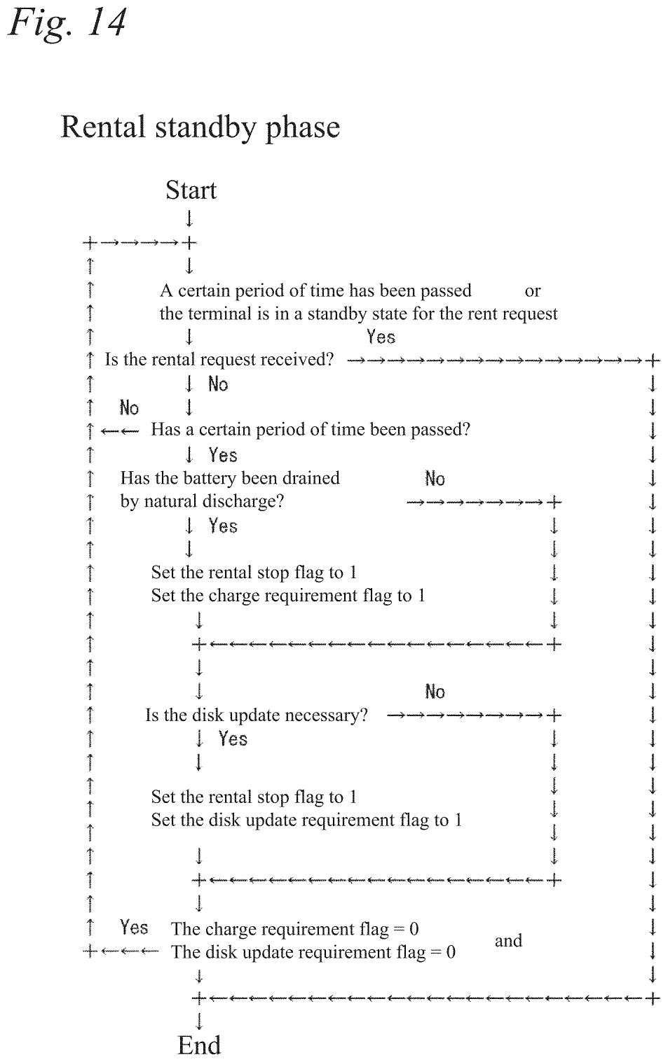

FIG. 14 is a processing flowchart of a rental standby phase.

The process of “the terminals in rental standby state” will be described. If a terminal C is stored and left in a terminal locker 20, its battery will be drained by natural discharge. Also, even for the terminal that was once determined to be “unnecessary to update storage”, the need for distribution may arise later due to changes in circumstances, such as a “change in reservation” or “a new version becoming available for distribution.”

Regarding this, for example, the “charge state” and “presence/absence of new discs” or “changes in reservations” are checked according to a predetermined schedule in FIG. 14. When it is determined that some operations are necessary, then, charging, updating, or other operation is performed.

### Return Phase

It is considered important to provide a mechanism to find out if there is any damage to the terminal when it is returned. However, “damage to the terminal” can be physical damage (e.g., the keyboard is removed, the housing or screen is cracked) and software damage (e.g., the operating system does not boot, system files are corrupted). The more time spent on checking all of these, the longer the user has to wait to return the terminal, leading to inconvenient system. In addition, if the system is designed for unattended operation, the user must see whether there is any physical damage when return the terminal. In that case, it must be assumed that the user may miss damaged parts or falsely report it, or that people may make different judgments depending on the degree of damage even if there is no malicious intent.

One possible solution to this problem is that the user starts the terminal only once when returning it and then shut it down immediately after confirming that the system has been booted normally. Even if some of the files that do not affect system startup are damaged or erased, they can be repaired (restored) after the terminal is returned as long as system can boot normally because the disk image can be re-distributed from the server. In addition, if the terminal is started and shut down immediately after the cable is connected, the waiting time required to return the terminal can be minimized. On the other hand, the physical damage can be configured to be checked when the terminal is rented instead of when being returned. In other words, if the user confirms any physical damage in the terminal that can be visually confirmed when renting it, the user can immediately return the terminal and rent another one. The users are likely to be more proactive in reporting a physically damaged terminal, because they do not want to use a damaged terminal, even if the damage is relatively small, such as cracks or chips in the housing, which do not interfere with actual use.

### REFERENCE SIGNS LIST

C: terminal
100: terminal rental management device
10: terminal rental system
20: terminal locker
50: reservation management server
60: power feed control server
70: terminal management server
1: Ethernet switch for control
2: Ethernet switch for communication
11: card reader
12: operation part
12a: display
12b: card reader
12c: camera
13: access point of a wireless LAN
21: terminal storage section
21a: terminal tray
22: terminal management box
23: cable
23a: connector
24: locking mechanism
25 (25a, 25n): movable bars
28: terminal locker controller
30: power supply circuit part (AC adaptor and SSR)
31: power tap
32: UPS
33: AC/DC converter
34: NFB (No Fuse Breaker)
35: Ethernet switch for control
36: Ethernet switch for communication
37: control power supply for terminal management box
41: power feed controller
42: PD controller
43: temperature sensor
44: contact sensor or the like (various sensors)
53: switching hub
54: distribution board

1. A terminal rental system comprising:
a reservation management server for managing stock of terminals or rental reservation information for the terminals;
a terminal management server for distributing a disk image of an operating system or its update data to the terminals; and
a power feed control server for managing a system state and a power feed state of the terminals on a basis of the rental reservation information, a charge state of the terminals, and information relating a distribution status of the disk image or its update data.

2. The terminal rental system according to claim 1, wherein both of charging to the terminals and the distribution of the disk image or its update data to the trminals are performed through a single interface having both charging function and two-way communication function.

3. The terminal rental system according to claim 2,
wherein the power feed control server comprises a power feeding control mechanism,
wherein, when a cable is connected through the interface while one of the terminals is stored, the power feed control server examines a “necessity of changing” of each of the terminals connected to the cables and determines a necessity of charging for each of the terminals, and
wherein the power feed control mechanism starts power feeding to the terminals determined to need charging, so that a total of power consumptions required when the terminals are started does not exceed a maximum power predetermined, after it is determined whether to start power feeding on a basis of the maximum power, which each of the terminals can consume when the terminals are started, without immediately charging each of the terminals.

4. The terminal rental system according to claim 2,
wherein the power feed control server further comprises: a terminal locker having a plurality of terminal storage sections for storing while locking the terminals; and a function to manage locking statuses of the terminals.

5. The terminal rental system according to claim 3, further comprising a function that determines a “necessity of updating a storage” of each of the terminals by examining the “necessity of updating a storage” of each of the terminals to which the cable is connected, and that updates the terminal storage sections determined to need to be updated.

6. The terminal rental system according to claim 3,
wherein the reservation management server calculates a charging completion time on a basis of the determination result of the “necessity of charging” and determines a date and time when the terminals can be rented.

7. The terminal rental system according to claim 5,
wherein the reservation management server calculates a charging completion time and an update completion time of the storage on a basis of the determination results of the “necessity of charging” and the “necessity of updating a storage” and determines a date and time when the terminals can be rented.

8. The terminal rental system according to claim 1, comprising an information display for displaying terminal rental information and information of charging or storage update of the terminals returned.

9. The terminal rental system according to any one of claims 1 to 8 claim 1,
wherein the reservation management server rents only the terminals that have completed charging and the distribution of the disk image of the operating system or its updated data, among all the terminals stored in the terminal storage sections.

10. The terminal rental system according to claim 1,
wherein the reservation management server has a function to update the storage state of the terminals before the time that each of the terminals is rented based on the information about the operating environment of each of the terminals, which the user specified when reserves.

11. The terminal rental system according to claim 1,
wherein the terminal management server has a function to back up the disk image of the operating system when each of the terminals is returned.

12. The terminal rental system according to claim 11,
wherein the terminal management server further comprises means for saving the disk image of the terminals returned by the user, and for recording and associating rental information and information on the operating environment of the user, and
a mean for, when the reservation management server receives a next rental reservation, preparing the terminals with the saved disk image restored before the reserved rental date and time.

13. The terminal rental system according to claim 4, wherein a terminal management box is provided in each of the terminal storage sections, and the cable is hanging down from an upper part of the terminal management box.

14. The terminal rental system according to claim 4, wherein the power feed control server locks one of the terminal storage sections after detecting that the cable is properly connected to one of the terminals, when the one of the terminals is returned to one of the terminal storage sections.

15. The terminal rental system according to claim 4,
wherein, when one of the terminals is taken out from one of the terminal storage sections, the power feed control server unlocks one of the terminal storage sections after detecting that the cable is properly removed from one of the terminals.

16. The terminal rental system according to claim 4, wherein a storage space of the terminal storage sections can be adjusted according to the size of the terminals to be stored.

17. The terminal rental system according to claim 5, wherein the determination of the “necessity of charging” or the “necessity of updating a storage” is repeated according to a predetermined schedule.

18. The terminal rental system according to claim 4, wherein a housing of the terminal locker is provided by a rail type tray that can be pulled out to the outside of the housing with the terminals placed.

19. The terminal rental system according to claim 1,
wherein the terminal rental system authenticates the user when one of the terminals is rented and identifies when one of the terminals is returned, and
the terminal rental system does not inquire whether one of the terminals is to be rented or returned.

20. The terminal rental system according to claim 1, comprising voice guidance that guides rental and return operations of the terminals.

21. The terminal rental system according to claim 4, comprising a light-emitting part in the vicinity of the terminal storage sections, the light-emitting part guiding the rental and return operations of the terminals.

22. The terminal rental system according to claim 21, the light-emitting part leads the user to store the terminals in the terminal storage sections having a proper size according to the size of the terminals when one of the terminals is returned.

23. The terminal rental system according to claim 1, wherein the operating system is started and shut down when one of the terminals is returned.

24. The terminal rental system according to claim 1,
wherein one of the terminals is started only once when being returned, and
one of the terminals is shut down immediately after it is confirmed the terminal rental system has been booted normally.

25. The terminal rental system according to claim 2,
wherein the power feed control server further comprising a terminal locker having a plurality of terminal storage sections for storing terminals while locked, and the ability to manage the locking status of the terminals.

26. A terminal rental system for managing a rental of a plurality of terminals to a plurality of users identified in advance for a certain period of time,
wherein the terminal rental system is equipped with a power feed control server that manages a power feed state of the terminals based on information on a charge state of the terminals,
and the power feed control server determines whether or not charging is required for each of the terminals by examining the charge state of all terminals to which the cable is connected when a cable is connected to one of the terminals during storage, and the terminal rental system is equipped with a power feed control mechanism that determines whether or not to start power supply based on the maximum power that the terminals can consume when it is started without immediately charging the terminals, so that the total power consumption required to start the terminals does not exceed the maximum power feed power set in advance and the terminal rental system is characterized by determining which of the terminals to lend out based on the charge state of the terminals.

27. A terminal rental system according to claim 26,
further equipped with a terminal locker having a plurality of terminal storage sections for storing terminals while locking them, and having a function to determine which terminals to lend based on their state of charge and to manage their locking status.

28. A terminal rental system that manages the rental of a plurality of terminals to a plurality of users identified in advance for a certain period of time,
wherein the terminal rental system is equipped with a terminal management server that distributes a disk image of an operating system or updated data thereof to the terminals, and the terminal management server manages a system status of the terminals based on the information on the distribution status of the disk image of the terminals or its update data, and
when a cable is connected to one of the terminals via an interface of the terminals during storage of the terminals, and
when a cable is connected to one of the terminals via the interface during storage, the terminal rental system status of all terminals to which the cable is connected is examined to determine whether or not a system update is required for each of the terminals, and a system update is performed for each of the terminals that is determined to require a system update, and
the terminal rental system is characterized by determining the terminals to be lent out based on the status of the system update.

29. A terminal rental system for managing the rental of a plurality of terminals to a plurality of users identified in advance for a certain period of time,
wherein the terminal rental system is equipped with a terminal locker having a plurality of terminal storage sections for storing the terminals while locking them and when one of the terminals is returned to the terminal storage sections, one of the terminal storage section is locked, and then the cable is connected to one of the terminals through an interface of the terminals and the terminal rental system is characterized by the fact that each of the terminals is determined to have been returned.

30. A terminal rental system for managing the rental of a plurality of terminals to a plurality of users identified in advance for a certain period of time,
wherein the terminal rental system is characterized by authenticating the user without authenticating the terminals to be lent out at the time of lending, and identifying the terminals without authenticating the user at the time of return.

31. A terminal rental system according to claim 30, for managing the rental of a plurality of terminals to a plurality of users identified in advance for a certain period of time, wherein the terminal rental system is equipped with a terminal locker having a plurality of terminal storage sections for storing the terminals while locking them, and the terminal rental system prompts the user to store the terminals in the appropriate size terminal storage sections according to the size of the identified terminals at the time of return.

32. A terminal rental system for managing the rental of a plurality of terminals to a plurality of users identified in advance for a certain period of time, wherein the terminals are booted up at least once upon return of the terminals and shut down immediately after confirming that the terminal rental system has booted up properly.

33. A terminal rental system for managing the rental of a plurality of terminals to a plurality of users identified in advance for a fixed period of time comprising a terminal management server that delivers a disk image of the operating system or its updated data to the terminals, wherein the terminal management server boots the terminals at least once to confirm that the terminal rental system has booted normally upon return of the terminals, restores them to the saved disk image, and then shuts them down.
